(19) United States
(12) Patent Application Publication
(10) Pub. No.: US 2016/0226184 A1
(43) Pub. Date: Aug. 4, 2016

(54) Connector Assembly and Connector

(71) Applicant: Tyco Electronics Japan G.K., Kanagawa (JP)

(72) Inventors: Tetsuya Katano, Kanagawa (JP); Akira Kubo, Kanagawa (JP); Chihiro Hikage, Kanagawa (JP)

(73) Assignee: Tyco Electronics Japan G.K., Kanagawa (JP)

(21) Appl. No.: 15/009,044

(22) Filed: Jan. 28, 2016

(30) Foreign Application Priority Data
Jan. 30, 2015 (JP) 2015-016866

(51) Int. Cl. H01R 13/627; H01R 12/79

(52) U.S. Cl. CPC H01R 13/627; H01R 12/79

(57) ABSTRACT

A connector assembly is disclosed. The connector assembly comprises a first connector having a housing and a lock portion, and a second connector having a catch portion. The lock portion includes a plurality of lock spring members each fixed to the housing at one end of the lock spring member. The catch portion interferes with the plurality of lock spring members in a first position, and is caught in the plurality of lock spring members in a second position.

### CROSS-REFERENCE TO RELATED APPLICATION

This application claims the benefit of the filing date under 35 U.S.C. §119(a)-(d) of Japanese Patent Application No. 2015-016866, filed Jan. 30, 2015.

### FIELD OF THE INVENTION

The invention relates to a connector assembly, and more particularly, to a connector assembly composed of a first connector and a second connector assembled to each other.

### BACKGROUND

A connector connecting a flexible printed circuit (FPC) to a circuit board is required to have a minimal height. Further, for ease of use, the connector is also required to have a mechanism where the connector can be securely locked and can be easily unlocked if necessary.

JP 2010-177003A discloses a connector having a lock mechanism of a push-on type. This connector has a lock spring that is circular in cross section. In the case of this lock mechanism, locking and unlocking are performed by utilizing elastic deformations of the lock spring. However, the lock mechanism disclosed in JP 2010-177003A is unsuitable for a connector with a reduced height, such as a board mounting type connector.

### SUMMARY

An object of the invention, among others, is to provide a connector assembly that is suitable for a low-profile connector, and can be securely locked and easily unlocked as necessary. The disclosed connector assembly comprises a first connector having a housing and a lock portion, and a second connector having a catch portion. The lock portion includes a plurality of lock spring members each fixed to the housing at one end of the lock spring member. The catch portion interferes with the plurality of lock spring members in a first position, and is caught in the plurality of lock spring members in a second position.

### BRIEF DESCRIPTION OF THE DRAWINGS

The invention will now be described by way of example with reference to the accompanying figures of which:

FIG. 1(A) is a perspective view showing a second connector according to a first embodiment of the present invention;

FIG. 1(B) is a perspective view showing a first connector according to a second embodiment of the present invention;

FIG. 2 is a perspective view showing a state where the second connector has been locked to the first connector shown in FIG. 1;

FIG. 3 is an exploded perspective view of one end portion of the first connector;

FIG. 4 is an exploded perspective view showing a state where lock spring members at one end portion of the first connector have been fixed to a housing;

FIG. 5(A) is cross-sectional view of a lock portion of the first connector and a catch portion of the second connector, in which the first connector and second connector are not in contact;

FIG. 5(B) is a cross-sectional view of a lock portion of the first connector and a catch portion of the second connector, in which the first connector and second connector are in a connecting first position;

FIG. 5(C) is a cross-sectional view of a lock portion of the first connector and a catch portion of the second connector, in which the first connector and second connector are in a fully connected second position;

FIG. 6 is an exploded perspective view of one end portion of a first connector of a second embodiment;

FIG. 7 is an exploded perspective view showing a state where lock spring members at one end portion of the first connector of the second embodiment have been fixed to a housing;

FIG. 8 is an exploded perspective view of one end portion of a first connector of a third embodiment;

FIG. 9 is an exploded perspective view showing a state where lock spring members at one end portion of the first connector of the third embodiment have been fixed to a housing;

FIG. 10(A) is perspective view showing a second connector according to a fourth embodiment of the present invention;

FIG. 10(B) is a perspective view showing a first connector according to a fourth embodiment of the present invention;

FIG. 11 is a perspective view showing a state where the second connector has been locked to the first connector shown in FIG. 10;

FIG. 12 is an exploded perspective view of one end portion of the first connector of the fourth embodiment; and

FIG. 13 is an exploded perspective view showing a state where a lock spring member at one end portion of the first connector of the fourth embodiment has been fixed to a housing.

### DETAILED DESCRIPTION OF EMBODIMENT(S)

The invention is explained in greater detail below with reference to embodiments of a connector assembly. This invention may, however, be embodied in many different forms and should not be construed as limited to the embodiments set forth herein; rather, these embodiments are provided so that this disclosure will be thorough and complete and still fully convey the scope of the invention to those skilled in the art.

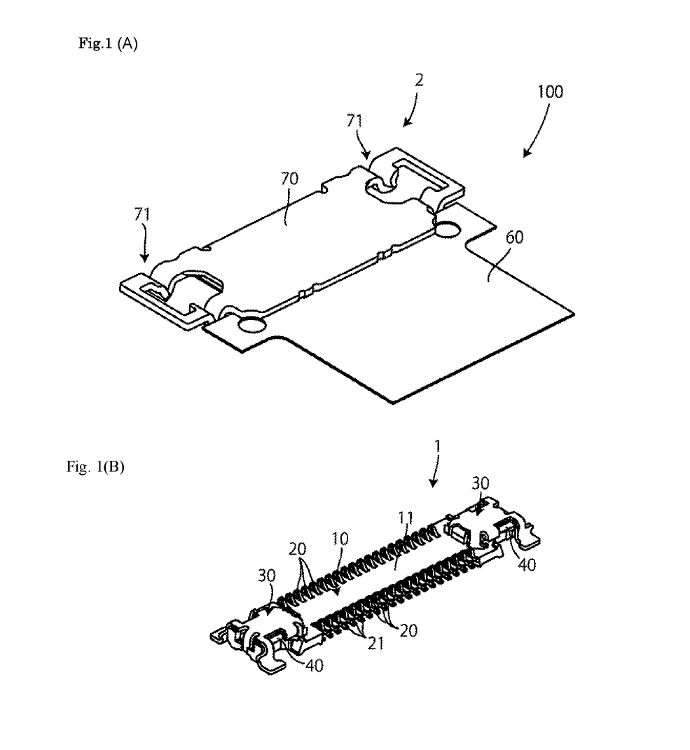

FIG. 1 shows a first connector 1 and a second connector 2 constituting a connector assembly 100 according to an embodiment of the invention. Here, in relation to an orientation of fitting, a second connector 2 is shown in FIG. 1(A), while a first connector 1 is shown in FIG. 1(B). The major components of the invention will now be described in greater detail.

As shown in FIG. 1(B), the first connector 1 is provided with a housing 10 having an approximately rectangular parallelepiped and a plurality of contacts 20 supported by and attached to the housing 10 and arranged in two rows. Arrangement of the contacts 20 is not limited to two rows, but it may be in one row or three or more rows. The housing 10 has a mating face 11. Each contact 20 has a board connecting portion 21 configured to be connected to a surface of a circuit board (not shown) by soldering. Further, the first connector 1 is provided with lock portions 30 at both ends of the housing 10.

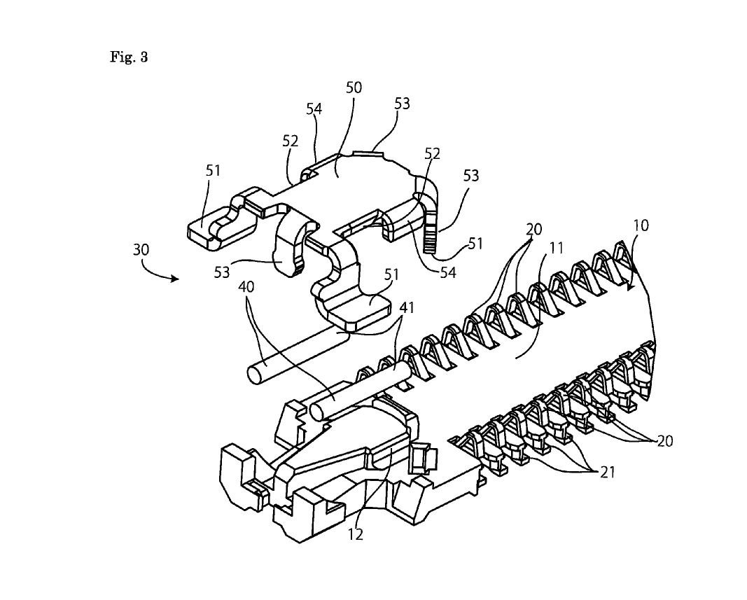

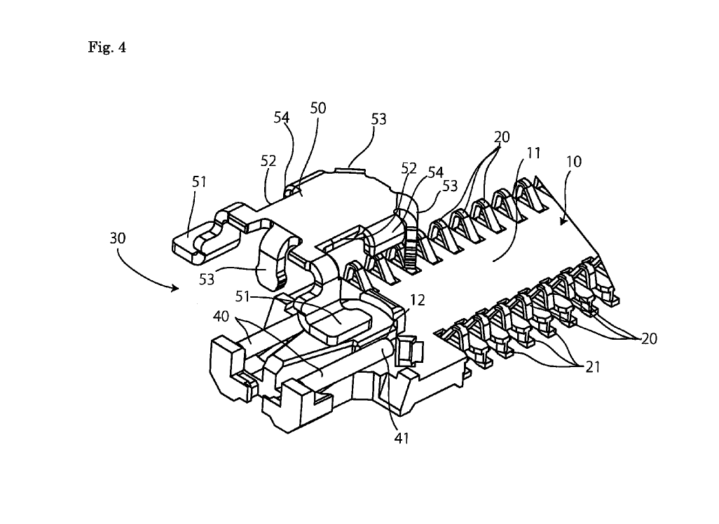

Lock portions 30 are provided at both end portions of the first connector 1, respectively. As shown in FIG. 3, each lock portion 30 is provided with two lock spring members 40 and a reinforcement metal fitting 50. The lock spring member 40 is a wire material formed of a piano wire, a stainless steel or the like. These lock spring members 40 are arranged in parallel with the mating face 11 of the housing 1 and in parallel with each other. End portions 41 of the respective lock spring members 40 are each clamped and fixed between an upstanding wall 12 of the housing 10, as shown in FIG. 4, and a downwardly-extending portion 54 of the reinforcement metal fitting 50. The end portions 41 may be press-fitted into grooves (not shown) of the housing 10.

The reinforcement metal fitting 50 is a metal member covering the lock spring members 40 and clamping the lock spring members 40 with the housing 10. However, even in such as state where the lock spring members 40 have been covered with the reinforcement metal fitting 50, portions of the lock spring members 40 are exposed at notched portions 52 of the reinforcement metal fitting 50.

The reinforcement metal fitting 50, as shown in FIGS. 3 and 4, is provided with board fixing portions 51 at a total of four portions thereof. The four board fixing portions 51 are configured to be soldered to the circuit board (not shown) together with the board connecting portions 21 of the contacts 20. Further, three press-fitting portions 53 press-fitted into the housing 20 are provided on the reinforcement metal fitting 50. Incidentally, bottom faces of two of the three press-fitting portions 53 form the board fixing portions 51. By these board fixing portions 51 and press-fitting portions 53, the first connector 1 is fixed to the circuit board, and the lock spring members 40 are retained by the housing 20.

Referring back to FIG. 1(A), the second connector 2 is provided with a flexible printed circuit (hereinafter, called “FPC”) 60. The second connector is not limited to one for the FPC 60, and it may be a connector where contacts and catch portions have been fixed to a housing. A FFC (flexible flat cable) may be used instead of the FPC. Further, the second connector 2 is provided with a metal shell 70 fixed to one end of the FPC 60. Here, the FPC 60 actually has a longitudinal size longer than one shown in this FIG. 1(A), and only one end of the FPC 60 provided with the metal shell 70 is shown here. Conductor pads (not shown) are provided on a lower face (a face facing toward the side of the first connector 1) of a portion of the FPC 60 covered with the metal shell 70. The conductor pads are provided at positions corresponding to the plurality of contacts 20, respectively.

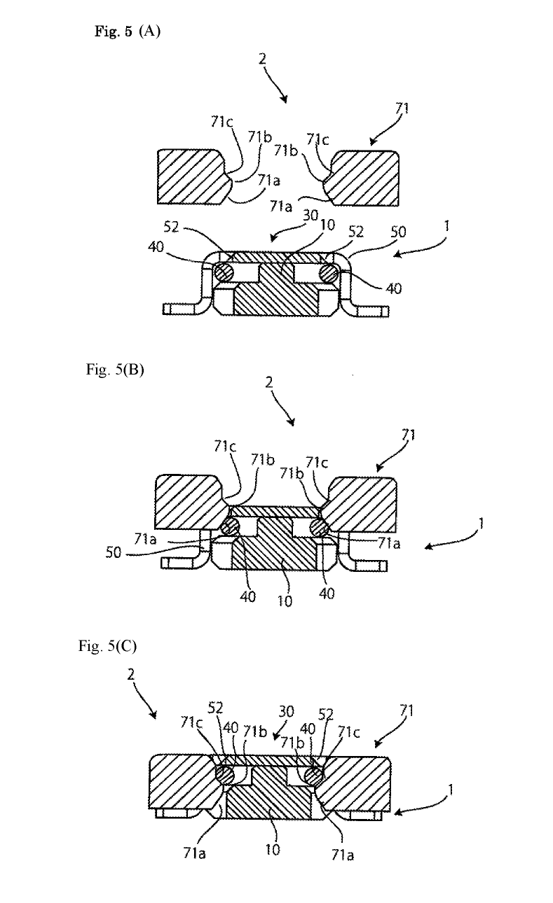

Catch portions 71 are provided at both ends of the metal shell 70 of the second connector 2. As shown in FIG. 5(A), the catch portion 71 of the metal shell 70 of the second connector 2 is provided with slopes 71a, top portions 71b, and catching recessed portions 71c. The slopes 71a have a shape opened toward the first connector 1. Further, the top portions 71b are projection portions continuing to the slopes 71a. Further, the catch portions 71c are portions with a slightly recessed shape continuing to the top portions 71b.

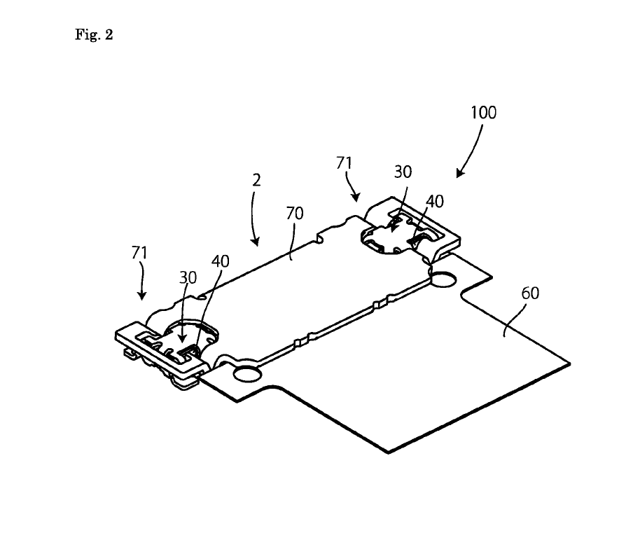

As shown in FIG. 2, the second connector 2 is mated with the first connector 1 by causing the catch portions 71 to be caught in the lock portions 30 such that the second connector 2 is stacked on the first connector 1. By this mating, the respective conductor pads (not shown) on the bottom face of the FPC 60 come in contact with the respective contacts 20 of the first connector 1. Wirings on the FPC 60 are electrically connected via the conductor pads and the contacts 20 to a circuit provided on the circuit board (not shown) on which the first connector 1 is mounted.

In FIG. 5, cross-sectional views of the lock portion 30 of the first connector 1 and catch portion 71 of the metal shell 70 of the second connector 2 are shown during stages of connection.

In FIG. 5(A), a state where the lock spring members 40 have been clamped between the housing 10 and the reinforcement metal fitting 50 in the lock portion 30 is shown. However, as described above, the two lock spring members 40 are put in a partially exposed state from the notched portions 52 of the reinforcement metal fitting 50.

As the second connector 2 contacts the first connector 1 in a connecting first position, shown in FIG. 5(B), the catch portions 71 enter the notched portions 52 of the reinforcement metal fitting 50 to interfere with the lock spring members 40. The two lock spring members 40 are elastically deformed so as to come close to each other by abutting the slopes 71a.

The second connector 2 is brought further closer to the first connector 1, and as shown in FIG. 5(C), the top portions 71b of the catch portions 71 pass through the two lock spring members 40. The two lock spring members 40 are restored from the elastic deformations to enter and abut the catching recessed portions 71c in the fully connected second position.

The lock portions 30 of the first connector 1 and the catch portions 71 of the second connector 2 are provided at both end portions of the first connector 1 and the second connector 2, respectively. Therefore, the catching shown in FIG. 5 is performed at both ends of the first connector 1 and the second connector 2, and the second connector 2 is caught in the first connector 1.

As shown in FIG. 5(C), the lock mechanism is a lock mechanism suitable for height reduction where catching is performed within the same thickness as that of the first connector 1. Further, when the second connector 2 must be detached from the first connector 1, the second connector 2 is strongly pulled up. Thereby, catching of the second connector 2 on the first connector 1 is released. The lock spring members 40 are firmly fixed by the reinforcement metal fitting 50. Therefore, the lock spring members 40 are prevented from being detached from the first connector 1 according to the lock releasing. Accordingly, it is possible to perform attachment and detachment of the second connector 2 to and from the first connector 1 repeatedly.

In the exemplary embodiment described above with reference to FIG. 5, the lock mechanism elastic deformation brings the two lock spring members 40 close to each other, however, as would be understood by one with ordinary skill in the art, the two lock spring members 40 could alternatively be elastically deformed so as to move away from each other.

In figures representing the following additional embodiments, the same reference signs as those used in the previous figures are used for ease of understanding. Further, only different points from the first embodiment will be described.

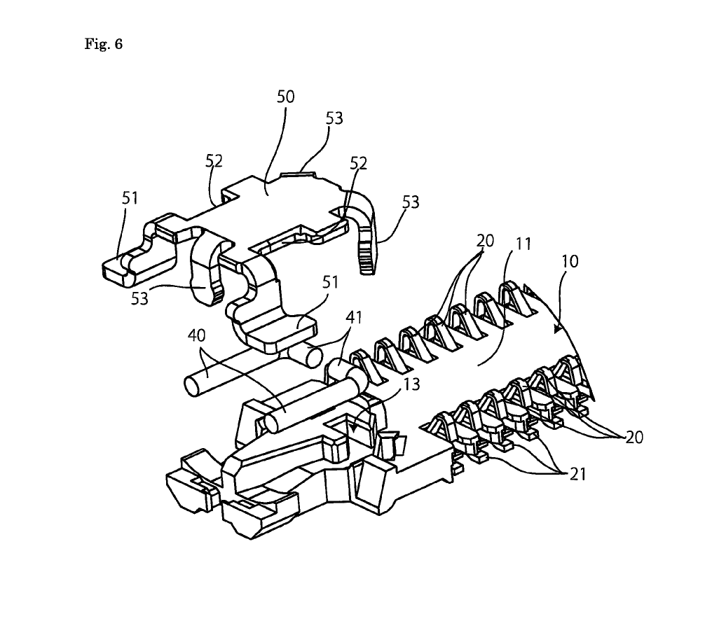

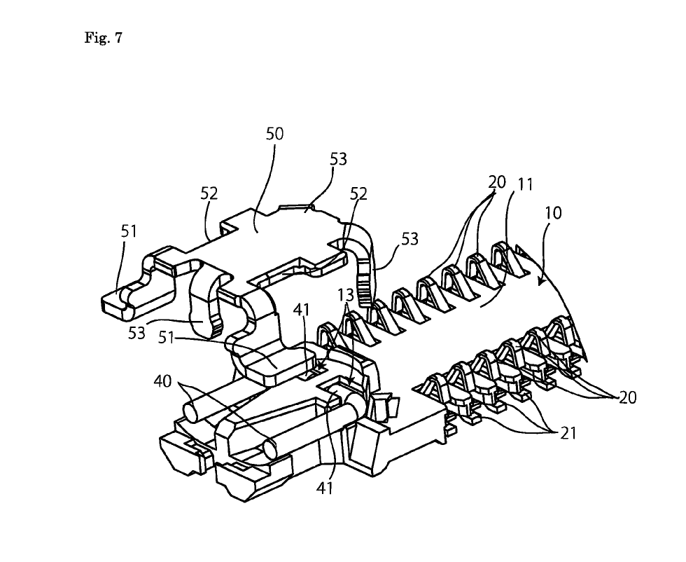

FIGS. 6 and 7 show a second embodiment of the present invention. As shown in FIG. 6, the lock spring members 40 of the second embodiment have folded end portions 41 press-fitted into the housing 10. The folded end portions 41 are press-fitted into grooves 13 formed in the housing 10, as shown in FIG. 7. Thereby, the lock spring members 40 are additionally fixed in the housing 10 as compared with the first embodiment.

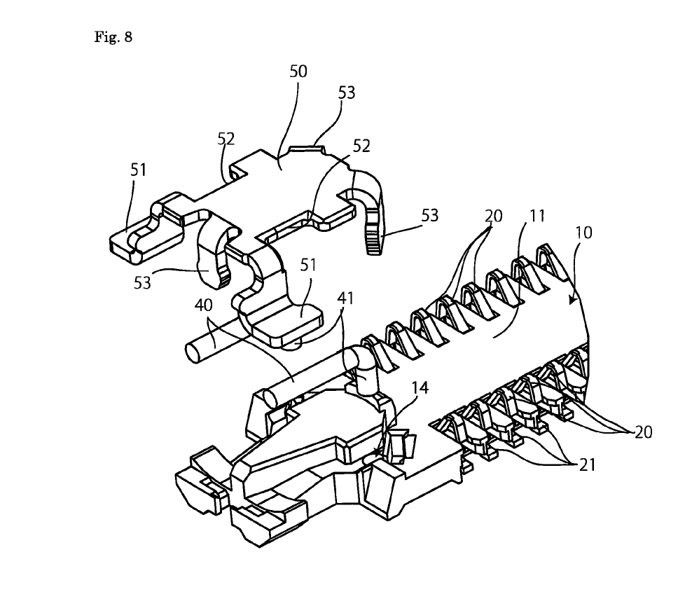

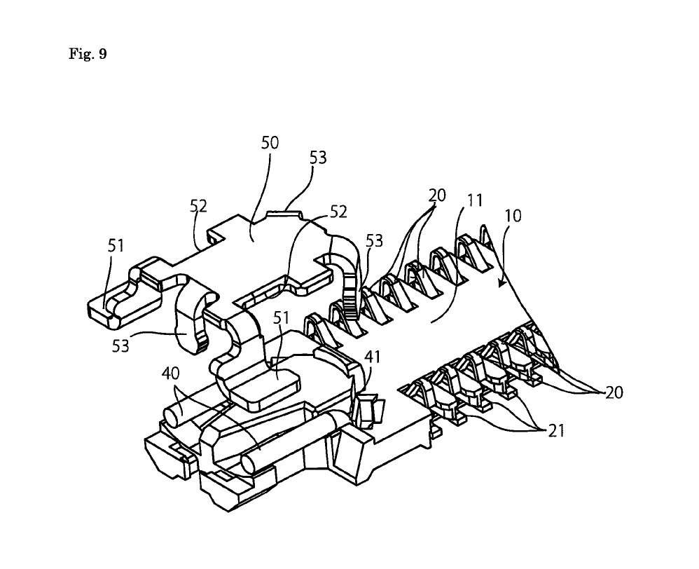

FIGS. 8 and 9 show a third embodiment of the present invention. A lock spring member 40 of the third embodiment is a member with the same bar shape as that of the lock spring member 40 of the second embodiment; that is, the lock spring member 40 of the third embodiment has a hook-shaped portion where an end portion 41 press-fitted into the housing 10 has been folded. In the third embodiment, however, the orientation of the lock spring member 40 is different from that of the second embodiment. The end portion 41 of the lock spring member 40 of the third embodiment is press-fitted into a hole 14 formed in the housing 10. In this structure, the end portion 41 of the lock spring member 40 is also fixed to the housing 10 more firmly as compared with the first embodiment.

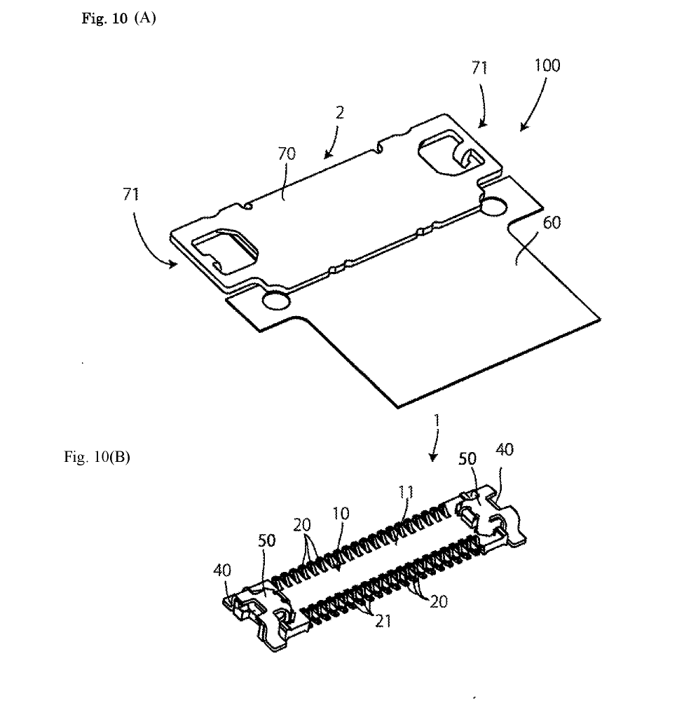

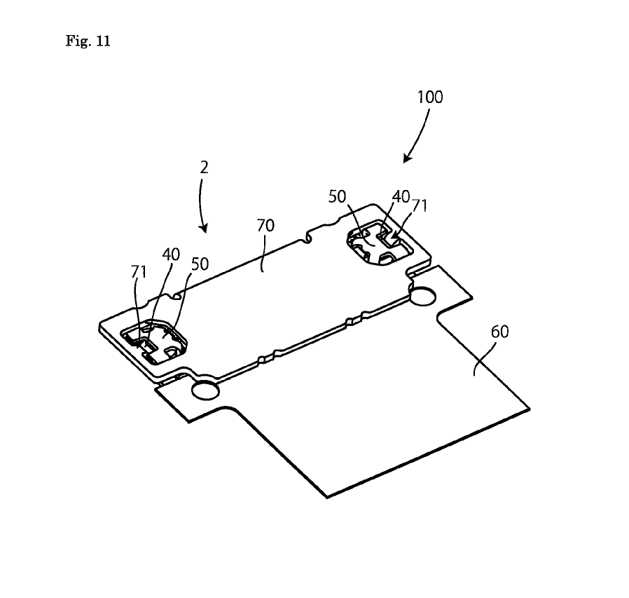

FIGS. 10-13 show a fourth embodiment of the present invention. In FIG. 10, in relation to an orientation of mating, the second connector 2 is shown in FIG. 10(A), while the first connector 1 is shown in FIG. 10(B) in the same manner as the case shown in FIG. 1. The connector in the fourth embodiment is different from the connector assembly 100 in the above-described first embodiment regarding a shape of the reinforcement metal fitting 50 and a shape of the catch portion 71 of the metal shell 70. The reinforcement metal fittings 50 provided at both end portions of the first connector 1 in the fourth embodiment are each formed with only one notched portion 52. In addition, the notched portion 52 is directed toward the outside of the housing 10 in a longitudinal direction of the housing 10, as shown in FIG. 10.

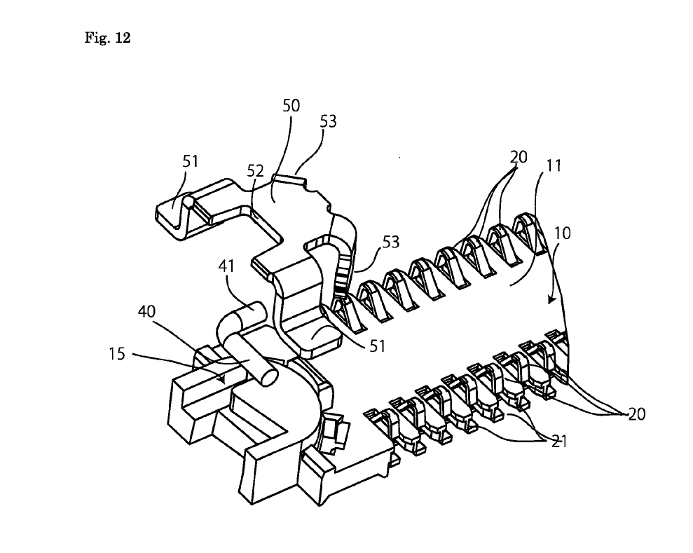

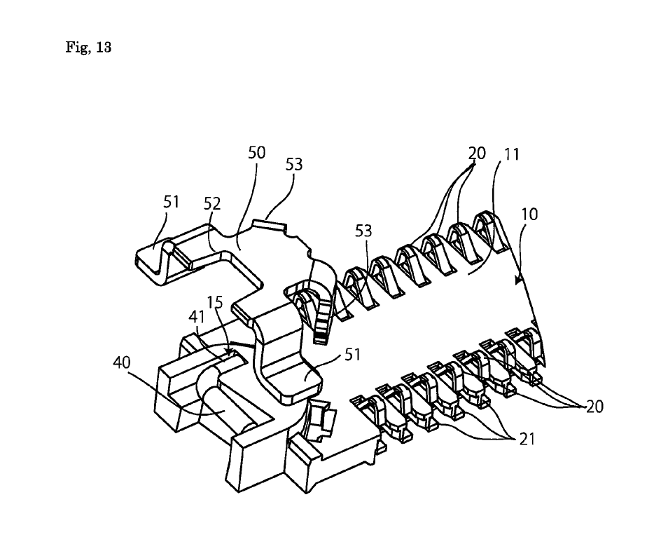

Only one lock spring member 40 is provided, and the lock spring member 40 is also oriented in the longitudinal direction in the fourth embodiment. As shown in FIGS. 12 and 13, the lock spring member is placed with an orientation traversing the housing 10, and an end portion 41 thereof fixed to the housing 10 is folded to extend in the longitudinal direction of the housing 10. The end portion 41 of the lock spring member 40 is press-fitted into a groove 15 of the housing 10. The lock spring member 40 is exposed from the notched portion 52 of the reinforcement member 50.

During mating of the connectors 1, 2, the catch portions 71 at both end portions of the metal shell 70 in the longitudinal direction elastically deform the lock spring members 40 at the both end portions of the first connector 1 in the longitudinal direction so as to come close to each other. When fully connected, the elastic deformation is released to reach a state where the second connector 2 has been locked to the first connector 1. The two lock spring members 40 are separated from each other by a length of the first connector 1 in the longitudinal direction. In the fourth embodiment, a single lock portion is formed by combination of the both end portions of the first connector 1. In the case of the fourth embodiment, the number of lock spring members 40 is reduced to reduce the cost and number of required assembling steps.

In the exemplary embodiment described above with reference to the fourth embodiment, the lock mechanism elastic deformation brings the two lock spring members 40 close to each other, however, as would be understood by one with ordinary skill in the art, the notched portion of the reinforcement metal fitting could be directed inward and the lock spring members deformed so as to be move away from each other.

Advantageously, since the first connector 1 of the present invention is provided with two lock spring members 40 arranged in the above-described orientations, an attachable and detachable lock mechanism is realized for a low-profile connector. In a further advantage, the shape of the lock spring members 40 prevents tangling and improves assembly. Typically, many lock spring members 40 are stored collectively during shipping or automatic assembly. The lock spring members 40 of the connector assembly 100 of the first embodiment have round bar shapes or a simple folded shape. Consequently, when one lock spring member 40 is lifted up, a plurality of lock spring members 40 will not be tangled with each other, and assembly is easier.

What is claimed is:

1. A connector assembly, comprising:
a first connector having a housing and a lock portion, the lock portion including a plurality of lock spring members each fixed to the housing at one end of the lock spring member; and
a second connector having a catch portion interfering with the plurality of lock spring members in a first position and caught in the plurality of lock spring members in a second position.

2. The connector assembly of claim 1, wherein the lock spring members extend in parallel with each other and in parallel with a mating face of the housing.

3. The connector assembly of claim 1, wherein the catch portion has a plurality of slopes, a plurality of top portions, and a plurality of catching recessed portions.

4. The connector assembly of claim 3, wherein the slopes abut the lock spring members in the first position.

5. The connector assembly of claim 4, wherein the slopes deflect the lock spring members in opposite directions to each other in the first position.

6. The connector assembly of claim 5, wherein the catching recessed portions abut the lock spring members in the second position.

7. The connector assembly of claim 6, wherein the lock spring members are restored from deflection in the second position.

8. The connector assembly of claim 7, wherein the second connector abuts the first connector in the second position.

9. The connector assembly of claim 1, wherein the first connector also has a reinforcement metal fitting.

10. The connector assembly of claim 9, wherein the reinforcement metal fitting clamps the lock spring members between the reinforcement metal fitting and the housing.

11. The connector assembly of claim 1, wherein the second connector also has a flexible printed circuit with a plurality of conductors.

12. The connector assembly of claim 11, wherein the catch portion is on a metal shell fixed to the flexible printed circuit.

13. The connector assembly of claim 11, wherein the first connector also has a plurality of contacts attached to the housing.

14. The connector assembly of claim 13, wherein, in the second position, the plurality of conductors contact the plurality of contacts.

15. The connector assembly of claim 1, wherein the housing has two opposite end portions, and one lock spring member at each end portion.

16. The connector assembly of claim 1, wherein the housing has two opposite end portions, and two lock spring members at each end portion.

17. A connector, comprising:
a housing; and
a lock portion including a plurality of lock spring members each fixed to the housing at one end of the lock spring member.

18. A connector, comprising:
a catch portion interfering with a plurality of lock spring members provided in a mating connector in a first position, and caught in the plurality of lock spring members in a second position.
